(19) United States
(12) Patent Application Publication
(10) Pub. No.: US 2007/0164492 A1
(43) Pub. Date: Jul. 19, 2007

(54) Vibration mounting

(75) Inventor: Paul Cook, Leicester (GB)

Correspondence Address: EDWARDS ANGELL PALMER & DODGE LLP, P.O. BOX 55874, BOSTON, MA, 02205, US

(73) Assignee: Trelleborg AB, SE-321 22 (SE)

(21) Appl. No.: 10/574,340

(22) PCT Filed: Oct. 7, 2004
(86) PCT No.: PCT/GB04/04249

§ 371 Date: Jan. 3, 2007

(30) Foreign Application Priority Data
Oct. 9, 2003 (GB) 0323611.4

(51) Int. Cl. F16F 7/00; F16M 1/00

(52) U.S. Cl. 267/141; 248/638

(57) ABSTRACT

A vibration mounting comprises a base member (10) for mounting to a mounting location and a support member (14) for supporting a load. The support member is spaced apart from the base member in a load-bearing direction by a vibration-isolating element (18) of a resilient material. The vibration mounting has a centre-line in the load-bearing direction. The vibration-isolating element comprises a plurality of lobes (24) on each side of a plane passing through the centre-line. Each lobe (24) extends from the base member (10) towards the support member (14) and also extends in a lateral direction different from that of other lobes. Each lobe (24) has an upper surface engaging the support member and at least one free surface.

The present invention relates to a vibration mounting. In particular, but not exclusively, the present invention relates to a vibration mounting for an engine.

Vibration mountings are known in which a resilient rubber material is sandwiched between a base member secured to a foundation (e.g. a floor such as the hull of a boat or a frame), and a support member. The support member is attached to a foot or mounting point on an engine or other piece of equipment that may be subjected to vibrations. The purpose of the vibration mounting is to isolate the vibration energy of the engine and so prevent damage to the engine or to equipment or personnel located nearby.

A problem with such vibration mountings arises when the vibration frequency is low, especially, for example, in two or three-cylinder marine engines. Such engines are used in smaller sea-going vessels and not only generate low frequency vibrations themselves, but are subjected to increased loadings on the mountings due to the pitching and rolling motion of the vessel. Marine engines, as with many types of engine, are now producing more power now than they ever have, giving rise to a need for a mounting that provides the required vibration isolation combined with a high thrust load capacity.

Furthermore, the engines are often mounted directly to the hull of the vessel and transmission of vibrations from the engine could result in weakening of the hull with potentially disastrous consequences. To isolate the low frequency vibrations, large displacements of the rubber material are required. Large displacements require larger volumes of rubber to ensure adequate absorption of vibration energy while maintaining reasonable service life. This means that vibration mountings of known design would have to be unacceptably large or unable to be used on existing or industry-standard mounting positions to be suitable for low frequency isolation.

A further problem is that excessively large displacements are undesirable because they may damage engine components or equipment connected to the engine such as gear trains or fuel lines. This problem is particularly severe in two and three-cylinder marine engines, when operating at maximum capacity because very high loads are transmitted in the direction of the engine thrust (longitudinal direction). Thus a higher rate of resistance to large displacements (stiffness) is required in this direction, while maintaining isolation in the vertical and/or lateral directions. This is usually achieved by fitting thrust bearings to the power output shaft of the engine, adding considerably to the installation cost.

Although it is known to use hydraulic mountings to dampen low frequency vibrations, these mountings provide inadequate isolation of higher frequency vibrations. High frequency vibrations are transmitted through the hydraulic fluid, which behaves like a solid in such conditions.

It is an object of the present invention to provide a vibration mounting which alleviates these problems.

According to the present invention there is provided a vibration mounting comprising a base member for mounting to a mounting location and a support member for supporting a load, the support member being spaced apart from the base member in a load-bearing direction by a vibration isolating element of a resilient material, the vibration mounting having a centre-line in said load-bearing direction: wherein the vibration isolating element comprises a plurality of lobes on each side of a plane passing through said centre-line; wherein each lobe extends from the base member towards the support member and also extends in a lateral direction different from that of other lobes; and wherein each lobe has an upper surface engaging the support member and at least one free surface.

Preferably, the lateral direction is substantially orthogonal to the load-bearing direction.

It is an advantage that deflection of the load-bearing member towards the base member causes deformation of the lobes by a combination of shear and compression. Deformation by shear provides a lower stiffness than pure compression and allows large deflections without the need for an excessive quantity of material. It is a further advantage that the lobes provide an increased free surface area for allowing lateral expansion of the rubber material when compressed, thereby further reducing the compression stiffness of the rubber element.

Preferably the lobes are arranged to extend outwardly from a central portion of the vibration isolating element secured to a raised portion of the base member, and at an angle to the base member, an outward end of each lobe engaging a corresponding portion of the support member. The corresponding portion of the support member may be an end portion extending towards the base member that bears against an outer end surface of the lobe. It is an advantage that the end portions provide support for the load in the longitudinal direction, provide accurate control of stiffness, ensure that the rubber lobes are compressed in use, and substantially reduce the friction caused by relative movement between the lobes and the support member.

In a preferred embodiment, the support member comprises one or more buffer members extending towards the base member between adjacent lobes of the vibration isolating element such that the buffer member contacts a resilient material buffer secured to the base member when vibration displacements exceed a predetermined amplitude.

Preferably, the vibration isolating element comprises an elastomeric polymer formed by injection moulding to the base member. Conveniently, the resilient material buffer and the vibration isolating element are formed as an integral injection moulded unit.

It is an advantage that, for a given size of mounting, by arranging the buffers between adjacent lobes the thickness of resilient material disposed between the base member and support member can be sufficient to provide isolation of large amplitudes of vibration displacements as occur at low frequencies. For example, in embodiments of the invention, system natural frequencies as low as 6 Hz may be encountered.

In a preferred embodiment, the mounting location has a predetermined footprint and includes predetermined fastener positions within the footprint for securing the base member, the vibration mounting being sized to fit the predetermined footprint. The fastener positions may be holes for accepting mounting bolts.

The lobes are preferably arranged so as to allow access to, and not interfere with, the fastener positions.

In a preferred embodiment, the buffer member may contact the resilient material buffer when vibration displacements exceed a predetermined amplitude in a first direction.

The resilient material buffer may be provided with means for reducing friction when contacting the buffer member. The friction reducing means may be contact plates of nylon or other suitable low friction material. This prevents excessive wear or frictional heat generation when vibrations cause the contacting surfaces of the support member and the vibration isolating element to rub against one another.

In a preferred embodiment, in the first direction the vibration mounting further comprises a secondary buffer for further increasing resistance to displacement beyond a second predetermined amplitude of vibration displacement. It is an advantage that this dual buffering provides for greater control of vibration displacements and is particularly appropriate in applications such as the mounting of two or three-cylinder marine engines where increased resistance is required in a thrust direction when the engine is operating at a high capacity.

In a preferred embodiment, the vibration mounting includes further buffers for increasing resistance to displacement (stiffness rate) of the support member relative to the base member in the load-bearing direction and in a third direction beyond a threshold displacement in each direction. Preferably, the load-bearing, first and third directions are substantially mutually orthogonal directions.

It is an advantage that, in embodiments of the invention, different thresholds and stiffness rates may be provided in each direction, thereby allowing for differences in the control of vibrations in each direction. It is a further advantage that the control of displacements in each direction is provided in a single mounting.

Preferably, in the load-bearing direction the further buffer comprises a first buffer for increasing resistance to a positive displacement beyond a positive displacement threshold and a second buffer for increasing resistance to a negative displacement beyond a negative displacement threshold. The second buffer may be provided as a failsafe feature to prevent the support member and the base member becoming detached from one another in the event of a failure of the vibration isolating element.

Where the load bearing direction is the vertical direction, the positive and negative displacements being upward and downward displacements respectively, by providing different buffers for the upward and downward displacements allowance can be made for the dead weight of the load.

An embodiment of the invention will now be described with reference to the accompanying drawings, in which:

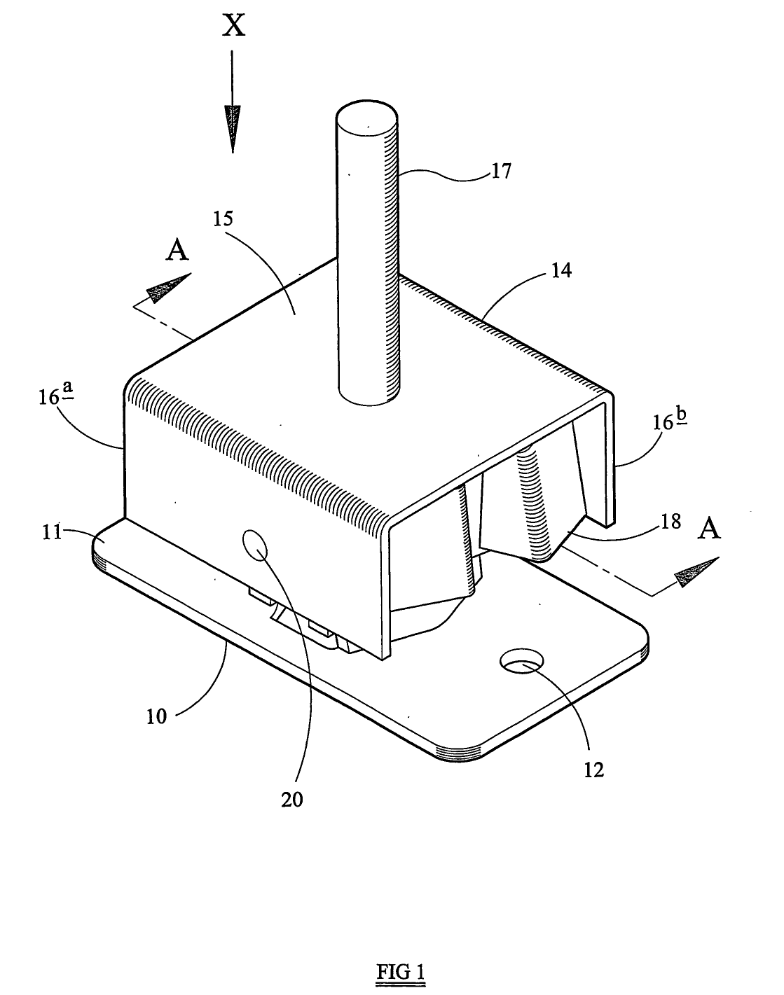

FIG. 1 is a three-dimensional isometric view of a vibration mounting according to the present invention;

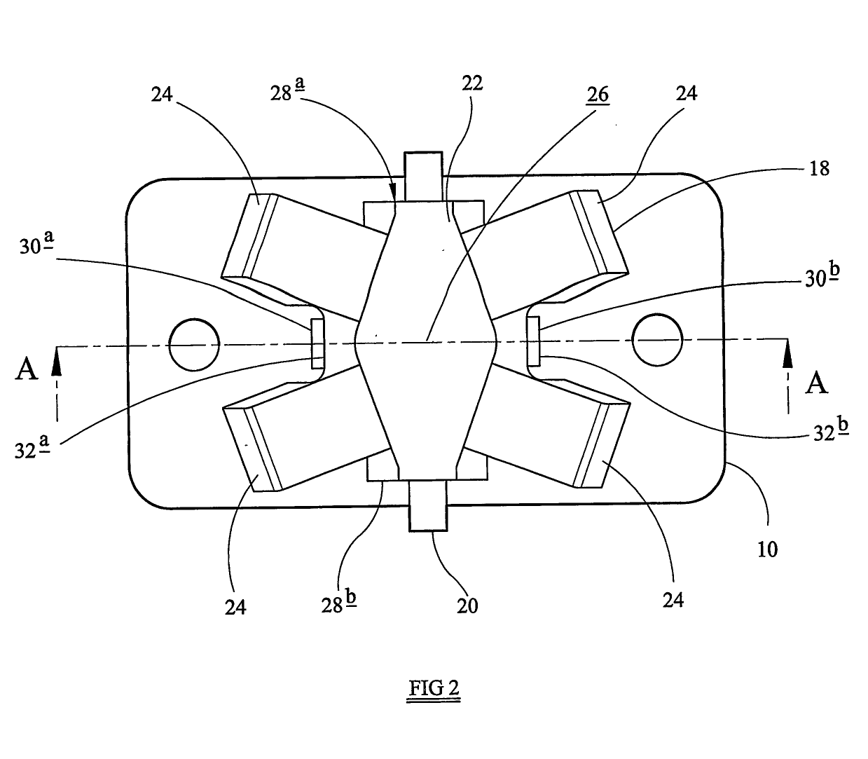

FIG. 2 is a plan view in the direction X of part of the vibration mounting of FIG. 1; and

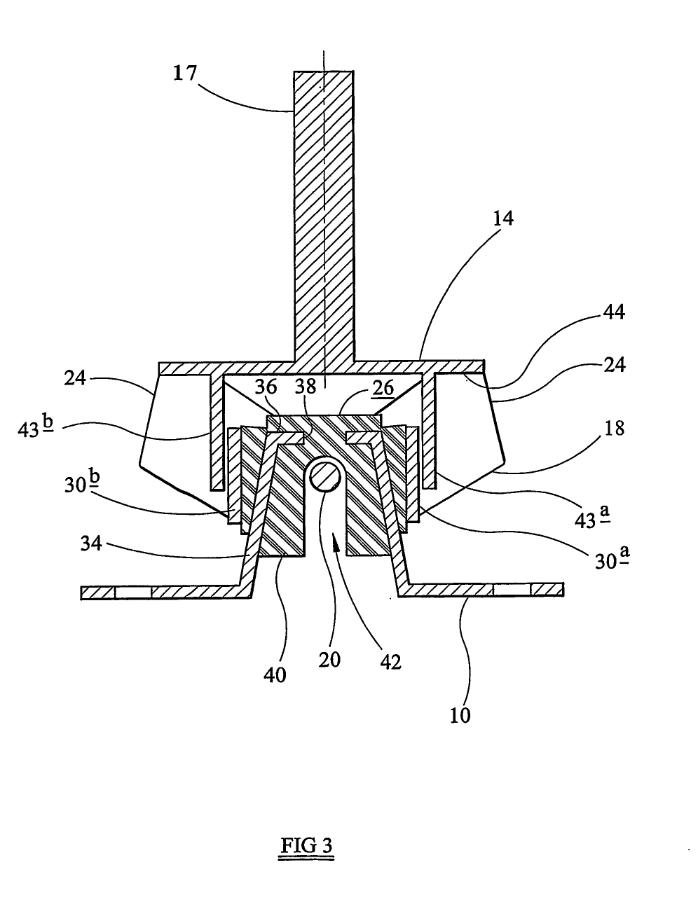

FIG. 3 is a sectional elevation in the plane A-A of the vibration mounting of FIGS. 1 and 2.

In marine engine applications, for example, 2 and 3 cylinder engines give rise to higher vibrations due to the difficulties of balancing the reciprocating masses in the engine. The vibrations that can also be low frequency are predominantly in the vertical direction. For the engine mounting system to be effective it must have a natural frequency below the oscillation frequency at idle speed. This means that the mounting must have low stiffness allowing a large deflection under the engine mass.

Referring to FIG. 1, a vibration mounting for an engine or other piece of machinery has a base member 10 which includes a plate portion 11. Holes 12 are provided in the plate portion 11 for bolting the vibration mounting to a floor or frame (not shown). The vibration mounting has a load-bearing support member 14 having a horizontal plate portion 15 between downwardly extending side walls 16a, 16b. The support member 14 is integrally formed with, welded to, or fixed by other means to an upwardly extending stud bolt 17 located centrally of the horizontal surface 15. In use, a hole provided in a footplate of an engine or other piece of machinery (not shown), is located over the stud bolt 17 onto the horizontal plate portion 15 of the load-bearing member 14 and secured in place with a nut. The footplate of the engine may not be in direct contact with the support member 14, but may be supported between two nuts screwed onto the stud bolt 17, thereby providing a height adjusting means.

The vibration mounting shown in FIGS. 1 to 3 is described herein for use as a horizontal mounting, but may be used in any orientation as required. In whichever orientation the vibration mounting is used, the predominant load-bearing direction should be that equivalent to the vertical direction of FIGS. 1 to 3.

The vibration mounting has a resilient rubber vibration-absorbing element 18 between the base member 10 and the support member 14. The base member 10, support member 14 and rubber element 18 are coupled together by a pin 20, as will be seen more clearly with reference to FIGS. 2 and 3.

FIG. 2 shows a plan view of the vibration mounting with the support member 14 of FIG. 1 removed. The rubber element 18 is an injection-moulded unit, which is shaped to provide vibration isolation and control of the extents of vibration displacements between the support member 14 and the base member 10. The rubber element 18 has a central portion 22 and four lobes 24 which extend outwardly and upwardly from the central portion in an X-shape as seen in FIG. 2. The central portion 22 of the rubber element 18 has an upwardly facing surface 26 and vertical surfaces 28a, 28b which face outwardly in opposing lateral directions. The central portion 22 of the rubber element 18 also carries a pair of nylon plates 30a, 30b on the vertical surfaces 32a, 32b facing outwardly in opposing longitudinal directions between respective pairs of the lobes 24. The nylon plates 30a, 30b are either fixed by adhesive to the vertical surfaces 32a, 32b, or bonded to the vertical surfaces 32a, 32b when formed by injection moulding.

The upwardly facing surface 26 is shown as a flat horizontal surface in FIGS. 2 and 3, but may be profiled to provide a softer buffer.

Referring to FIG. 3, the base member 10 includes an upwardly extending frusto-conical portion 34 with a flat top surface 36. One or more holes 38 are provided through the base member 10 in the top surface 36. The rubber vibration-absorbing element 18 is formed by injecting the rubber from above the frusto-conical portion 34 and through the holes 38 so as to be moulded to the base member 10. The rubber element 18 includes a lower portion 40 moulded to the underside of the frusto-conical portion 34. A U-shaped channel 42 is formed through the lower portion 40, extending across it in the lateral direction.

The support member 14 is coupled to the base member 10 and rubber element 18 by inserting a pin 20 through holes in the side walls 16a, 16b (as shown in FIG. 1) and through correspondingly aligned holes (not shown) in the frusto-conical portion of the base member 10. A central portion of the pin 20 rests within the curved surface of the U-shaped channel 42 in the lower portion of the rubber element 18. The upper surfaces of the lobes 24 bear against an underside 44 of the support member 14, and are compressed slightly when the vibration mounting is assembled.

Embodiments include the support member 14 having downwardly extending end portions that bear against the outer end surfaces of the lobes. This helps to provide further support for the load in the longitudinal direction. The end portions provide accurate control of stiffness, ensure that the rubber lobes are compressed, and substantially reduce the friction caused by relative movement between the rubber and the support member.

The support member 14 is further provided with a pair of downwardly extending arms 43a, 43b, which are spaced apart by an amount which is a little greater than the longitudinal separation of the outwardly facing surfaces of the nylon plates 30a, 30b, so as to leave a gap between each arm 43a, 43b and a corresponding nylon plate 30a, 30b. Similarly, the central portion 22 of the rubber element 18 is sized to have a lateral length slightly less than the lateral separation of the side walls 16a, 16b of the support member 14 so as to leave a gap between the side walls and the vertical surfaces 28a, 28b.

When an engine is mounted on the vibration mounting, the weight of the engine causes the lobes 24 to be compressed and to be deflected downwards so that the mounting plate 24 is pushed closer to the base member 10. The gap between the underside 44 of the support member 14 and the horizontal surface 26 of the central portion 22 of the rubber element 18 is reduced, while the gap between the pin 20 and the curved surface of the U-shaped channel 42 is increased. This downward displacement of the lobes does not affect the gaps between the downwardly extending arms 43a, 43b and the respective nylon plates 30a, 30b, nor the gaps between the side walls 16a, 16b and the corresponding vertical surfaces 28a, 28b.

In use the rubber lobes 24 reduce the transfer of energy from the vibrating load to the base member 10 in 3 ways: a) low stiffness allows the load to move (vibrate) with a low transfer of energy, b) by reducing the natural frequency of the system to a level below all normal running frequencies a resonance condition is avoided, and c) by energy absorption due to the damping effect of the rubber (hysteresis).

Vibration displacements of the support member 14 cause the lobes 24 to deform in compression or in shear. The free surfaces of the lobes are able to expand outwardly when so deformed and so provide a relatively low rate of energy transfer (stiffness). This means that under relatively mild vibration conditions, when vibration amplitudes are small enough for there to be no contact of the buffer surfaces, the stiffness of the rubber element 18 is relatively low. This is desirable because at low vibration frequencies, the displacement levels required to isolate the vibrations are high.

The arrangement of the lobes 24 has a further advantage in that low frequency vibration isolation can be achieved in a mounting having the same mounting bolt positions as existing, industry-standard mountings. Standard boat mountings have sub-frames that are 60 mm wide and have a standard bolt hole pattern (100 mm between bolt centres). The size of the mounting is very restricted by the space envelope exists, especially in small engine boats. In the embodiment described, the lobes extend outwardly away from the mounting bolt holes 12 in the plate portion 11 of the base member 10 and so are not fouled by the bolts. The mounting can therefore be secured using existing standard bolt positions.

However, when vibration levels become severe, then to prevent dangerously large vibration displacements, a higher rate of energy transfer is required. This is achieved by buffered limit control in vertical, lateral and longitudinal directions. Buffering protects the mounting as well as the engine and engine attachments (fuel lines, exhaust, propshaft, etc.) from excessive deflections.

In the lateral direction, vibration displacements greater than the size of the gap between the side walls 16a, 16b and the respective vertical surfaces 28a, 28b of the vibration-absorbing element 18, cause the gap to close. The rubber of the central portion 22 of the rubber element 18 acts as a buffer by absorbing more of the lateral vibration energy. In other words, there is an increase in the resistance to vibration displacements greater than the size of the gap. The increase in resistance depends on the material properties of the rubber as well as the thickness of rubber between the vertical surfaces 28a, 28b and the metal of the frusto-conical portion 34 of the base member 10.

A similar situation arises for the buffering of vertical displacements. However, in this case there is a difference between downward and upward displacements. For downward, or positive, displacements, the gap between the underside 44 of the support member 14 and the upwardly facing surface 26 of the rubber element 18 is closed until, for large displacements buffering occurs when contact is made. For upward, or negative, displacements, the gap between the pin 20 and the curved surface of the U-shaped channel 42 is closed until, for large displacements, buffering occurs when contact is made. The amount of buffering (the resistance to further displacement) in each case depends on the material properties of the rubber, the thickness of rubber between the contacting surface and the under or over-lying surface of the base member 10, and the area of contact. Thus a different degree of buffering can be provided for upward and downward displacements to allow for the effects of the dead weight of the engine.

In the longitudinal direction, a two-stage control of displacement is achieved. A first stage occurs when the gap between one of the downwardly extending arms 43a, 43b and the corresponding adjacent nylon plate 30a, 30b is closed. The nylon and rubber of the rubber element 18 between the nylon plate 30a, 30b and the frusto-conical portion 34 of the base member 10 acts as a first stage buffer. Greater displacement in the longitudinal direction closes the gap between the pin 20 and the side walls of the channel 42 in the lower portion 40 of the rubber element 18. This lower portion 40 acts as the second stage buffer. Again the degree of buffering depends on the relative dimensions of the contacting surfaces and the thickness and material properties of the rubber.

Two-stage buffering in the longitudinal direction means that this direction can be aligned with the primary thrust direction of the engine. Vibration displacements in the thrust direction require a greater degree of control, especially at high engine loads. Hitherto vibration isolation in this direction has required separate components such as thrust bearings to be used in addition to vibration mountings for the feet of the engine.

The nylon plates 30a, 30b are provided to reduce friction between the downwardly extending arms 43a, 43b and the buffer surface. Because vibrations can occur in all directions, when the downwardly extending arms contact the nylon plates, vibrations in directions parallel to the contacting surfaces cause the surfaces to rub against each other, and reduced friction between them reduces heat generation and wear.

Thus, a single vibration mounting may provide for vibration isolation and control in all three orthogonal directions even when the degree of control required is different in each direction.

1-18. (canceled)

19. A vibration mounting comprising a base member for mounting to a mounting location and a support member for supporting a load, the support member being spaced apart from the base member in a load-bearing direction by a vibration isolating element of a resilient material, the vibration mounting having a centre-line in said load-bearing direction;
wherein the vibration isolating element comprises a plurality of lobes on each side of a plane passing through said centre-line, wherein each lobe extends from the base member towards the support member and also extends in a lateral direction different from that of other lobes, and wherein each lobe has an upper surface engaging the support member and at least one free surface.

20. The vibration mounting of claim 19, wherein the lateral direction is substantially orthogonal to the load-bearing direction.

21. The vibration mounting of claim 19, wherein the lobes are arranged to extend outwardly from a central portion of the vibration isolating element secured to a raised portion of the base member, and at an angle to the base member, an outward end of each lobe engaging a corresponding portion of the support member.

22. The vibration mounting of claim 21, wherein the corresponding portion of the support member is an end portion extending towards the base member that bears against an outer end surface of the lobe.

23. The vibration mounting of claim 19, wherein the support member comprises one or more buffer members extending towards the base member between adjacent lobes of the vibration isolating element such that the buffer member contacts a resilient material buffer secured to the base member when vibration displacements exceed a predetermined amplitude.

24. The vibration mounting of claim 23, wherein the vibration isolating element comprises an elastomeric polymer formed by injection moulding to the base member.

25. The vibration mounting of claim 24, wherein the resilient material buffer and the vibration isolating element are formed as an integral injection moulded unit.

26. The vibration mounting of claim 23, wherein the resilient material buffer is provided with means for reducing friction when contacting the buffer member.

27. The vibration mounting of claim 26, wherein the friction reducing means comprises contact plates of nylon or other suitable low friction material.

28. The vibration mounting of claim 23, wherein the buffer member contacts the resilient material buffer when vibration displacements exceed a predetermined amplitude in a first direction.

29. The vibration mounting of claim 28, further comprising a secondary buffer for further increasing resistance to displacement beyond a second predetermined amplitude of vibration displacement in the first direction.

30. The vibration mounting of claim 23, including further buffers for increasing resistance to displacement of the support member relative to the base member in the load-bearing direction and in a third direction beyond a threshold displacement in each direction.

31. The vibration mounting of claim 30, wherein the load-bearing, first and third directions are substantially mutually orthogonal directions.

32. The vibration mounting of claim 30, wherein, in the load-bearing direction, the further buffer comprises a first buffer for increasing resistance to a positive displacement beyond a positive displacement threshold and a second buffer for increasing resistance to a negative displacement beyond a negative displacement threshold.

33. The vibration mounting of claim 32, wherein the second buffer is provided as a failsafe feature to prevent the support member and the base member becoming detached from one another in the event of a failure of the vibration isolating element.

34. The vibration mounting of claim 19, wherein the mounting location has a predetermined footprint and includes predetermined fastener positions within the footprint for securing the base member, the vibration mounting being sized to fit the predetermined footprint.

35. The vibration mounting of claim 34, wherein the fastener positions are holes for accepting mounting bolts.

36. The vibration mounting of claim 34, wherein the lobes are arranged so as to allow access to, and not interfere with, the fastener positions.

37. A vibration mounting comprising a base member for mounting to a mounting location and a support member for supporting a load, the support member being spaced apart from the base member in a load-bearing direction by a vibration isolating element of a resilient material,
wherein the vibration isolating element comprises a plurality of lobes, each lobe extending from the base member towards the support member and also extending in a lateral direction different from that of other lobes;
wherein the support member comprises at least one buffer member extending towards the base member between adjacent lobes of the vibration isolating element such that the buffer member contacts a resilient material buffer secured to the base member when vibration displacements exceed a first predetermined amplitude in a first direction; and
wherein the vibration mounting further comprises a secondary buffer for further increasing resistance to displacement beyond a second predetermined amplitude of vibration displacement in the first direction.

38. A vibration mounting comprising:
a base member for mounting to a mounting location;
a support member for supporting a load, the support member being spaced apart from the base member in a load-bearing direction by a vibration isolating element of a resilient material, the vibration isolating element comprising a plurality of lobes extending from the base member towards the support member; and
buffer means comprising a first buffer for increasing resistance to displacement of the support member relative to the base member in the load-bearing direction beyond a positive displacement threshold and a second buffer for increasing resistance to a negative displacement beyond a negative displacement threshold.

39. The vibration mounting of claim 38, wherein the second buffer is provided as a failsafe feature to prevent the support member and the base member becoming detached from one another in the event of a failure of the vibration isolating element.
